(19) United States
(12) Patent Application Publication
(10) Pub. No.: US 2013/0138267 A1
(43) Pub. Date: May 30, 2013

(54) METHOD AND APPARATUS FOR PROVIDING PROBABLE CAUSE RELATING TO VEHICLE NON-COMPLIANCE

(71) Applicants: Gerald Hignite, Elizabethtown, KY (US); James Halsey, EI Dorado, AR (US); Arnie Lambert, Hodgenville, KY (US); Tim Thomas, Elizabethtown, KY (US)

(72) Inventors: Gerald Hignite, Elizabethtown, KY (US); James Halsey, EI Dorado, AR (US); Arnie Lambert, Hodgenville, KY (US); Tim Thomas, Elizabethtown, KY (US)

(21) Appl. No.: 13/746,349

(22) Filed: Jan. 22, 2013

Related U.S. Application Data
(63) Continuation-in-part of application No. 12/583,258, filed on Aug. 18, 2009.

(51) Int. Cl. G06F 17/00

(52) U.S. Cl. CPC G06F 17/00
USPC 701/2

(57) ABSTRACT

The present invention provides systems, methods and devices to generate an indication or signal by an indicator device of a vehicle that is detectable near the vehicle regarding one or more statuses of the vehicle, such as insurance policy, registration, crimes, wanted persons, etc. The indicator device may produce the indication or signal based on a control signal sent from a remote control system to the indicator device via a network and/or broadcast transmitter. The control system may determine the control signal and vehicle status based on information from external database(s). The indicator device may also receive local status information regarding the vehicle or any person associated with the vehicle. Such local status information may be sent back to the control system as a report signal, which may be stored in a remote database. The indicator signal or report signal may be detected by law enforcement near the vehicle.

### CROSS-REFERENCE TO RELATED APPLICATIONS

This application is a continuation-in-part (CIP) application claiming priority benefit to U.S. patent application Ser. No. 12/583,258, entitled “Method and Apparatus for Insurance Verification,” having a filing date of Aug. 18, 2009, the entire contents and disclosure of which are incorporated herein by reference.

### BACKGROUND

1. Field of the Invention

The present invention relates to apparatuses, systems and methods for law enforcement, motor vehicle compliance, and insurance verification.

2. Related Art

Many states have enacted laws mandating insurance coverage for vehicles used on highways and roads for travel. Some of these laws set minimum amounts of coverage and similarly detailed requirements, while other laws simply mandate that all vehicles must be covered by an active insurance policy. Some states may require proof of insurance before a car receives its state or local registration papers. Often, however, there are very few verification methods to ensure compliance with these rules. As a result, a number of uninsured motorists may be present on roadways even though it is against the law. Even when proof of insurance is required, some people still find a way to circumvent the law. For example, one common technique is for a person to purchase insurance, then title and register their vehicle, and then simply cancel the insurance policy. This procedure can then be repeated each time the vehicle's registration is renewed.

Accordingly, despite the best efforts of state and local officials, there may still be a number of undiscovered uninsured drivers on the road at any time. It is not until a police officer performs a traffic stop that an uninsured motorist may be caught. However, making a traffic stop requires the officer to have some reasonable grounds for stopping a driver (e.g., “probable cause”). Because there is no readily observable or recognizable sign that a driver has no insurance, catching uninsured motorists is difficult and requires waiting until their driving leads to a traffic stop.

While the information about the status of insurance policies is present on each insurance company's computer system, this insurance policy information is not currently aggregated and accessible in a way that makes it available to law enforcement officers in a timely and up-to-date fashion. Likewise, other information about a vehicle (e.g., state vehicle registration, etc.) and/or any law-breaking by its occupants (e.g., for kidnapping, etc.) is also not readily discoverable by simply observing the vehicle prior to a traffic stop. Thus, there remains an unmet need for a system and method for alerting law enforcement personnel that a vehicle is currently uninsured or otherwise not in compliance with the law. There also remains a need in the art for a system and method for alerting law enforcement personnel when an occupant or driver of a vehicle has committed a crime or traffic violation.

### SUMMARY

According to a first broad aspect of the present invention, a system for determining a status of a vehicle is provided comprising: a control system database for storing one or more records, each record having status information for a particular vehicle and an associated vehicle identification number for the particular vehicle; a control system server configured to acquire the one or more records from an external database associated with an external server and store the one or more records in the control system database, the control system being further configured to determine a status for the particular vehicle associated with the vehicle identification number based on the status information in a respective record stored in the control system database; a broadcast transmitter configured to transmit a control signal, wherein the broadcast transmitter is further configured to receive the control signal communicated from the control system via the network, and wherein the control signal includes one or more instructions based on the status for the particular vehicle as determined by the control system; and an indicator device having a receiver configured to receive the transmitted control signal from the broadcast transmitter, wherein the control system is in communication with the external server associated with the external database such that the status information of each of the one or more records is communicated from the external server to the control system via the network, and wherein the indicator device is attached to the particular vehicle, the indicator device being further configured to display or send a detectable indication based on the instructions of the control signal received by the indicator device.

According to a second broad aspect of the present invention, an indicator device for coupling with a vehicle is provided comprising: a receiver configured to receive a control signal from a remote control system server, the control signal sent by the control system server to the indicator device via a broadcast transmitter, the control signal having one or more instructions that are determined by the control system server based on status information for the vehicle; a controller configured to determine if the control signal is addressed to the indicator device based on a unique device identification number associated with the indicator device or a vehicle identification number associated with a vehicle; and an indicator configured to display or send a detectable indication, wherein the controller controls the display or sending of the detectable indication of the indicator based on the one or more instructions of the control signal if the control signal is determined by the controller to be addressed to the indicator device. A vehicle comprising an indicator device of the present invention is also provided.

According to a third broad aspect of the present invention, a method is provided for determining a status of a vehicle, comprising: (a) acquiring by a control system server one or more records from an external database associated with an external server, the one or more records acquired via a network, wherein each record includes status information for a particular vehicle and a device identification number for an indicator device or an associated vehicle identification number for the particular vehicle; (b) determining a status of the particular vehicle by the control system server based on the status information in a respective record for the particular vehicle; and (c) transmitting a control signal via a broadcast transmitter, wherein the control signal is communicated from the control system server to the broadcast transmitter via the network, wherein the control signal includes one or more instructions based on the status for the particular vehicle as determined by the control system server.

According to a fourth broad aspect of the present invention, a method is provided comprising the following steps: (a) receiving by an indicator device a control signal transmitted by a control system to the indicator device via a broadcast transmitter, wherein the indicator device is attached to a particular vehicle, and wherein the control signal includes one or more instructions based on a status for the particular vehicle as determined by the control system; (b) determining by a controller of the indicator device whether the received control signal is addressed to the indicator device based on a device identification number for the indicator device or a vehicle identification number for the particular vehicle; (c) displaying or sending a detectable indication by the indicator device based on the instructions of the control signal received by the indicator device if the control signal is determined in step (b) to be addressed to the indicator device.

It is understood that other embodiments of the present invention will become readily apparent to those skilled in the art from the following detailed description, wherein it is shown and described only various embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF DRAWINGS

Various aspects of the invention are illustrated by way of example, and not by way of limitation, in the accompanying drawings, wherein:

FIG. 1 illustrates a system diagram of a system for verifying insurance in accordance with the principles of the present invention.

FIG. 2 illustrates a block diagram of an apparatus for verifying insurance in accordance with the principles of the present invention.

FIG. 3 is a flowchart of a method of verifying insurance coverage for a vehicle in accordance with principles of the present invention.

FIG. 4 is a flowchart of a method of verifying a valid registration for a vehicle in accordance with principles of the present invention.

FIG. 5 is a flowchart of a method of sending information gathered locally from or near the vehicle to the control system.

### DETAILED DESCRIPTION

The detailed description set forth below in connection with the appended drawings is intended as a description of various embodiments of the invention and is not intended to represent the only embodiments in which the invention may be practiced. The detailed description includes specific details for the purpose of providing a thorough understanding of the invention. However, it will be apparent to those skilled in the art that the invention may be practiced without these specific details. In some instances, well known structures and components are shown in block diagram form in order to avoid obscuring the concepts of the invention.

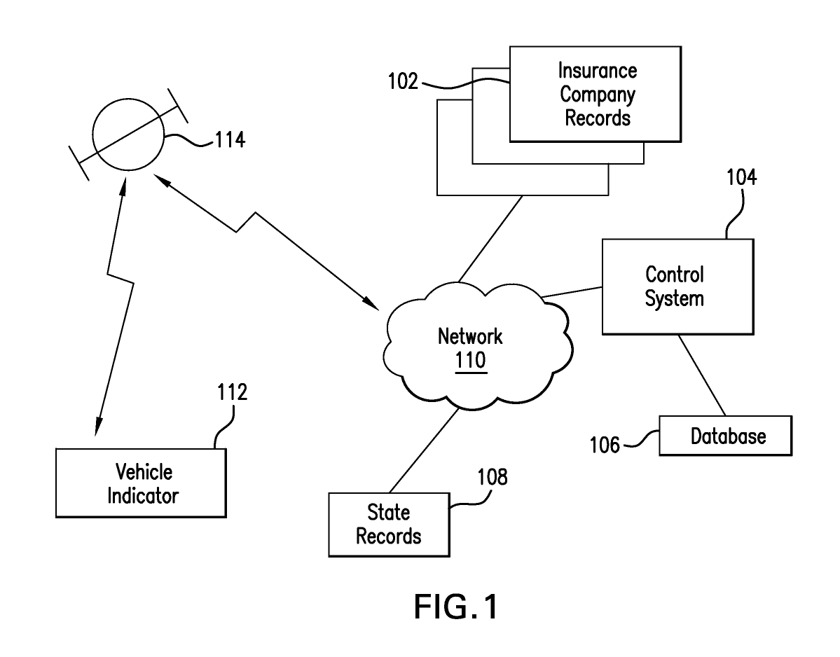

According to embodiments of the present invention, a system, method and device are provided that provide an indication or signal perceivable by an observer of a vehicle as to whether that vehicle is covered by a valid insurance policy. A database of policy information may be consulted by a control system that, in turn, generates a control signal that may be transmitted to an indicator device on a vehicle to control whether the indicator device signals that a valid insurance policy is in place for the vehicle or not. FIG. 1 illustrates a system diagram according to embodiments of the present invention for verifying insurance coverage for a plurality of vehicles. In the system of FIG. 1, a vehicle indicator 112 is attached, coupled, connected or associated with a particular vehicle that provides some type of detectable or observable indication to law enforcement personnel that the particular vehicle is (or is not) covered under a valid insurance policy.

The indication signal provided by the indicator 112 may preferably be visible or detectable in both daylight and nighttime conditions. For example, a high intensity light emitting diode (LED) may provide sufficient brightness to be seen in almost any conditions. An alternative may be for the indication signal from the indicator device to be at a radio frequency or any other wireless, electromagnetic (EM), satellite, or cellular signal that may be detected locally or elsewhere by a receiver, which may be appropriately tuned to receive signals at particular EM, satellite, cellular, radio or other frequencies. Such a receiver or receiving device may be in the possession of law enforcement officers or officials. The indication signal may preferably be detectable at short distances. These distances may vary and be adjustable, but may, for example, be within ¼ mile or less. Although designed for long distance transmission, satellite and/or cellular indication signals from the indicator device of the present invention may also be detected locally. Furthermore, indication signals in the form of satellite or cellular signals or transmissions may also be received and transmitted by a satellite or cellular network while optionally bypassing the central control system, such that the satellite-based or cellular-based indication signal may be transmitted or broadcasted and detected locally or elsewhere. Two or more types of indication signals may also be used in combination as well. Regardless of the manner of its sending, transmission, broadcasting, etc., an indication signal containing status information indicating that the vehicle is somehow associated with a violation of the law (either due to vehicle non-compliance or one of its owners or registered users violating the law) may be detected locally by a receiving device, and law enforcement may then use location information contained in the indication signal to intercept the vehicle associated with the legal violation and have the requisite “probable cause” in doing so.

In operation, the indication signal of the indicator 112 may have different states (e.g., different light colors, etc.) that indicate whether or not a valid insurance policy is in place that covers the vehicle to which the indicator 112 is attached. As another alternative, a pattern or sequence of lights or signals (e.g., flashing, alternating, marching, etc.) may also be used to indicate status information along with the color and/or duration of the light or signal. Regardless of the type or manner of indication or signal, the system of the present invention may give law enforcement personnel the legal grounds or “probable cause” needed to pull over or detain the vehicle displaying or presenting the indication or signal and/or arrest its occupants.

Proper operation of the indicator 112 may rely on other entities and/or components of the system to store information and provide control signals to the indicator 112 to control its indication status or signal output. The example system of FIG. 1 includes a control system 104, which may comprise one or more computer(s), server(s), etc., that manages one or more database(s) 106. The control system 104 may be a computer or web server connected to a network 110, such as the Internet, but may also be a server using more specialized and proprietary protocols to perform its functions, such as to connect and communicate with the indicator device 112.

Through the network 110, the control system 104 may communicate with insurance companies to have access to insurance company records 102, which may be stored on one or more database(s), server(s), etc., that are supervised, controlled or operated by the insurance company/companies. This communication and transfer of records information from the insurance company/companies to the control system 104 and database 106 may take place in a variety of different ways without departing from the scope of the present invention. For example, the insurance company/companies may initiate a session with the control system 104 and provide or push their latest records 102 (or the latest changes/updates to those records 102). Alternatively (or additionally), an operator of the control system 104 (or the control system 104 itself) may be provided access to the insurance company records 102 to retrieve or pull the latest records 102 (or the latest changes/updates to those records 102). Although it is generally preferred that this information is transferred to the control system automatically, it may also be acquired and entered manually. The access to the records information 102 of the insurance company/companies, or the receipt of records information 102 from the insurance company/companies, may be allowed or performed periodically or at intervals, which may be frequent (e.g., daily) to ensure that the information in the database 106 is up-to-date. However, longer intervals or periods (e.g., weekly, etc.) of access or receipt of this information are also possible. For example, an insurance company may provide the information through a telephone call so that the data is manually entered at the control system, the information may instead be provided through a web-based interface (assuming proper credential authentication), or the control system may access the insurance company's computer system to retrieve any new, updated or changed information. Regardless of the specific methods used, the control system 104 that manages the database 106 may store the latest records information (from the insurance company/companies) in the database 106.

FIG. 1 shows the insurance company records 102 being separate from the control system 104 and its database 106. This arrangement allows each insurance company to maintain its own records apart from the present system. The control system 104 may acquire the insurance company policy information and store it in the database 106 as described above. The insurance company policy information stored in the database 106 may include all insurance policy information (e.g., all the policy information currently maintained by insurance companies) or only a portion of the insurance policy information that is relevant to the present system. This arrangement may allow one central database 106 to be quickly updated so that the information in the database 106 is as accurate as possible. According to other embodiments, however, the insurance policy information in the insurance company records 102 may be acquired or accessed during operation of the control system 104 to determine insurance status for a particular vehicle(s), which may be only temporarily stored in a memory or storage device of the control system 104 (i.e., not permanently stored in a central database) long enough to at least generate and send a control signal to such vehicle(s).

The control system 104 may also include a transmit function to communicate with a broadcast transmitter such as, for example, the satellite 114 of FIG. 1 which transmits a control signal from the control system 104 to the vehicle indicator 112. The control signal may be a signal containing, or having embedded or encoded within it, instructions and/or status information. These signals may be further encrypted to avoid interception and access by third parties. Depending on the control signal received by the indicator device 112, the indicator 112 may signal or indicate whether an insurance policy is in place for the vehicle. Although a satellite-based system is contemplated according to some embodiments to provide significant coverage over most of the United States or other large geographic region(s), the broadcast transmitter that sends the control signal may not be a satellite but may be a cellular network, radio frequency transmitter, a pager system, or any other wireless network capable of reaching the boundaries of the region to be covered. These non-satellite types of transmitters may be especially appropriate for more local implementations of the present system.

Regardless of the type of transmitter used (e.g., satellite, cellular, etc.), the control signal may be communicated from the control system 104 to the transmitter by any suitable mode of communication, such as through a network or the Internet. An additional transmission function and interface may also be used to relay or send the control signal from the network, Internet, etc., to the transmitter as part of the mode of transmission and ultimately to the indicator device 112. Once the control signal is received by the transmitter, the transmitter may then transmit or broadcast that signal over a geographical area for receipt by the vehicle indicator 112.

In addition to insurance records, a vehicle also has associated registration, license and title information and other records usually maintained by a state and/or local government agency, such as in a state and/or local government records database 108. This data could be acquired via a network (in an analogous fashion to the insurance records information as described above) by permitted access to, and/or receipt of, these state or local government records by the control system 104. This registration and/or title information acquired by the control system may then be stored in the database 106, which may be along with (or integrated with) the insurance policy information described above. Control signal(s) may then be transmitted to the vehicle indicator 112 to display, indicate, or signal whether or not the car or vehicle has a valid insurance policy and/or vehicle registration. The control signal regarding the insurance policy status may be a separate signal from the control signal regarding the registration or title information, or they may be integrated or combined into a single control signal (e.g., as a packet). Likewise, any control signal(s) regarding other status information may be separate or combined with other control signal(s), such as those control signal(s) regarding insurance policy and/or registration status.

The database 106 may be used to store a variety of different data that simplifies the operation of the system of FIG. 1. For example, each vehicle indicator 112 for each vehicle may have an associated set of records related to the vehicle and/or the owner or listed user of that vehicle that may be stored in the database 106. The associated set of records may include the vehicle identification number (VIN), the active/inactive dates of an insurance policy, vehicle type and description, the expiration date of the current insurance policy, an insurance policy number (and company), license plate information, vehicle registration information, contact information for the owner of the vehicle, etc. These records may include information retrieved or sent from other database(s), such as government and/or insurance company database(s), and/or information received from a vehicle indicator device 112 associated with each vehicle. Information received from the vehicle indicator device 112 may relate to, or be based on, data regarding the operation or condition of the vehicle associated with the vehicle indicator device 112 and/or persons, events or activities present or occurring within or near, or affecting, such vehicle.

The system of the present invention allows for potentially an unlimited number of assignable and selectable inputs that may be gathered by the control system from remote locations or sources (i.e., from remote servers, computers, as well as data obtained from one or more vehicles, such as from one or more vehicle indicator devices of the present invention), which may be stored in its associated database. The inputs used for any particular application as well as the determinations and control signals made by the control system may be selected by the state or local agency implementing the system, such as to tailor the system for that jurisdiction's rules and regulations.

These inputs and information may include all of the types of status information referred to herein, such as insurance policy information, list of drivers on insurance coverage, registration and title information, contact and driver's license information, license plate numbers, VIN number, whether a vehicle is missing or stolen, whether a vehicle is breath analyzer equipped, history or location (GPS) information concerning the vehicle, etc. In addition, as discussed further below, additional inputs may include information gathered about an owner, registered driver or occupant of the vehicle or their activities or behaviors. For example, a search warrant for a particular individual or commission of a crime by a particular individual may be linked to a vehicle, such as by matching the name of the owner or registrant of the vehicle or of another person covered under the insurance policy for the vehicle, and a control signal may be sent to that vehicle for the vehicle indicator device to display or present an indication or signal. Other inputs may include other information about a person associated with vehicle, such as DUI/DWI status, arrests or driving restrictions, missing person information, other driving restrictions relating to corrective lens, night driving, under age drivers, passenger restrictions, etc.

Additional inputs or information that may be utilized by the system may include the time and length of operation of any cell phone calls, texting or web browsing by an occupant or driver of the vehicle, whether such cell phone use occurred while driving or moving, and what phone numbers were involved (both to and from) in the call or text. Moreover, additional inputs or information may include whether driver or passenger seat belt(s) are latched, such as when driving, and other driving related information, such as when collisions, air bag deployments and/or sudden stops or accelerations involving the vehicle occurred, etc.

Depending on where various relevant information originates, it may be communicated, transferred, transmitted, etc., differently through the system of the present invention. Data or information originating from the vehicle may be stored in the memory of the indicator device and/or sent to the control system. The sending of data or information from the vehicle indicator device to the control system may be via a vehicle-based transmitter (e.g., satellite, cellular, wireless, radio, etc.) and network, which may be by the same or different path used to send control signals or information to the indicator device from the control system. The vehicle based transmitter may be the same or different than the transmitter used to send acknowledgment of receipt of control signals from the control system. Such a vehicle-based transmitter of an indicator device may send information to the control system periodically, intermittently, when an event or condition is met, and/or when queried by the control system.

As mentioned above, all of the information originating from within or near the vehicle (e.g., cell phone use, seat belt latching, driving information, etc.) may be stored in a memory of the indicator device. The memory of the indicator device may comprise one or more memory devices at one or more locations within the vehicle or indicator device, and the memory of the indicator device may comprise one or more different types of memory. This information stored in a memory of the indication device may then be acquired by law enforcement personnel using a receiving device (to receive a signal with the information from the device) or a retrieving device (to pull or download the information from the device). Access to the memory for receipt or retrieval may be by wireless communication or by wired connection or plugging into the device. The memory may store any or all such information for a window or block of time. Such length of time may be long enough to keep sufficient information but not too long to make the device expensive. For example, days or weeks (e.g., two weeks) of information may be kept and stored in the memory.

Data or information acquired from the vehicle may include information local to the vehicle itself, such as information about the vehicle itself or its operation, any events affecting the vehicle, or information about a driver, owner, registered user or occupant of the vehicle or their behavior or conduct while inside the vehicle. Information about the operation of the vehicle, its location, its speed and movement, sudden stops, collisions or accelerations, the operational status or state of the vehicle, malfunctioning of any parts or portions of the vehicle, etc., that changes over time during operation and may thus only be acquired from the location of the vehicle itself. Some of this information may be acquired from the vehicle computer or its on-board GPS or other device. For example, the indicator device may be in communication with, and receive or acquire information from, the on-board diagnostics (OBD) computer of the vehicle, such as the OBD-II common today, that may detect and record various operational, status and diagnostic information about the vehicle and its operation, which may also be stamped with date and time information.

As another example of locally acquired information, cellular signals from use of a cellular phone by an occupant or driver of the vehicle may be detected by the indicator device, and the time, length and phone number information may be recorded and/or sent to the control system. As yet another example, the presence of another device, such as a house arrest device (e.g., bracelets, etc.), may be detected by the signals that they generate, and this information may be stored by the indicator device, such as in its memory, and/or sent to the control system where it may also be stored in the remote database.

The information sent to the control system from the indicator device may be embedded, encoded, contained, etc., within one or more report signal(s). Such a report signal may be non-visible and one or more of a satellite, cellular, wireless, or radio frequency signal depending on its path of transmission to the control system. Such a report signal(s) may be further encrypted to avoid interception and access to the information by third parties. However, information about the vehicle that is more static (e.g., VIN number, owner information, etc.) may be acquired from the vehicle itself or retrieved from another source (e.g., a government or insurance company database). By storing information locally (whether acquired locally from the vehicle or its occupants or from a remote database), such as in the memory of the indicator device, such information may be queried locally by law enforcement when encountering the vehicle.

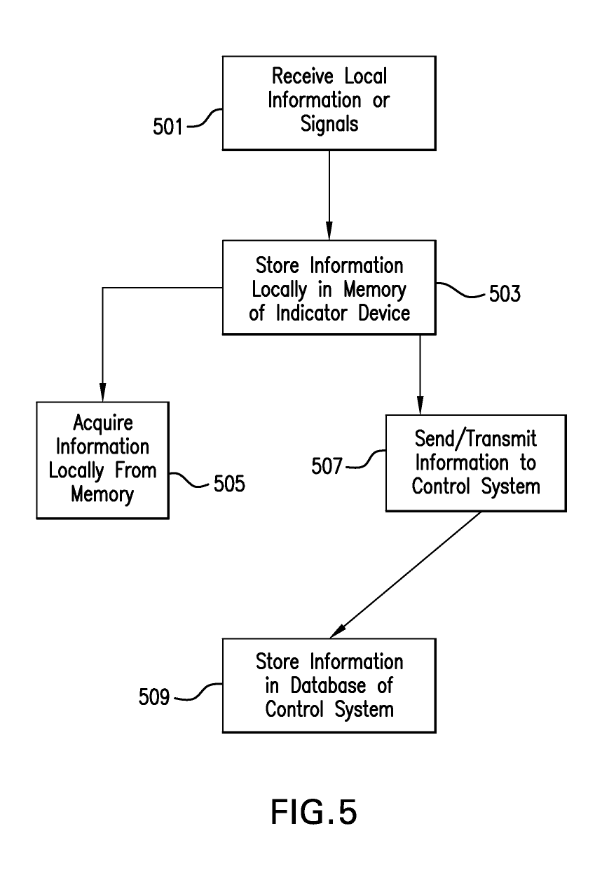

According to some embodiments of the present invention as shown in FIG. 5, a receiver or detector of an indicator device may receive or input local information or a signal(s) from a vehicle (e.g., OBD-II) or from within or near the vehicle (e.g., cell phone) in step 501. This information or signal may include any information or signals described herein that are local to the vehicle, such as driving or collision information, cell phone use, presence of house arrest device, etc. Such a receiver or detector may be the same as the receiver used to receive the transmitted signal from the control system via the transmitter, or it may be a separate or different receiver or detector. The information may then be stored locally in a memory of, or associated with, the indicator device in step 503. As an optional step, the information stored in the memory may be acquired locally by a law enforcement device via wired or wireless communication in step 505, which may be enabled by a local transmitter of the indicator device or by a plug into the indicator device. The information stored in the memory may also be sent or transmitted to a remote control system (e.g., as a report signal) via a transmitter and/or a network in step 507, which may be the same or different than the transmitter used to transmit control signal(s) in the reverse direction from the control system to the indicator device. The control system may then store that information in a database in step 509. The control system may then utilize this information to determine if a control signal should be sent to the indicator device to display or present an indication or signal.

Other inputs or information may originate from remote locations and be acquired by the control system from those remote locations. For example, as discussed above, current insurance policy information from insurance company servers, current title and registration status information from government and DMV databases, and criminal activities of individuals in law enforcement databases may be acquired from these sources, such as via a network connection. Such information and/or any control signals based on any of the acquired information may then be sent to the vehicle indicator device to follow the instructions and/or store the information locally, such as in the memory of the indicator device.

Embodiments of the present invention may also include a device able to block usage of a cell phone or other portable device. Technology has been developed that can block cell phone or Bluetooth® communications within a vehicle and may comprise a special blocking antenna mounted in the vehicle (e.g., under the headliner). Such technology may also be able to detect, determine, discriminate, etc., where the cell phone is being used within the vehicle (e.g., driver vs. passenger seat) and/or target blocking signals to the region of the driver's seat to prevent cell phone usage by the driver while driving. Such a system may also involve the indicator device of the present invention. If cell phone usage is detected (especially in the region of the driver's seat), this information may be received by the indicator device and recorded in its memory. The indicator device may be able to detect cell phone usage in or near the vehicle and determine or know if the vehicle is moving based on inputs from the GPS and/or vehicle computer (e.g., by connection to the Data Link Connector of the OBD-II). This information, including date, time, cell phone numbers, length of call, location of cell phone in vehicle when used, whether car was moving, etc., (whether detected or acquired directly or from other inputs) may also be sent or transmitted to the control system and may be stored in the control system database. The indicator device may also be linked (by wire or wirelessly) to the blocking technology or antenna and be configured to initiate the blocking signal if it is determined that a cell phone call is occurring (especially in the region of the driver's seat) while the vehicle is moving.

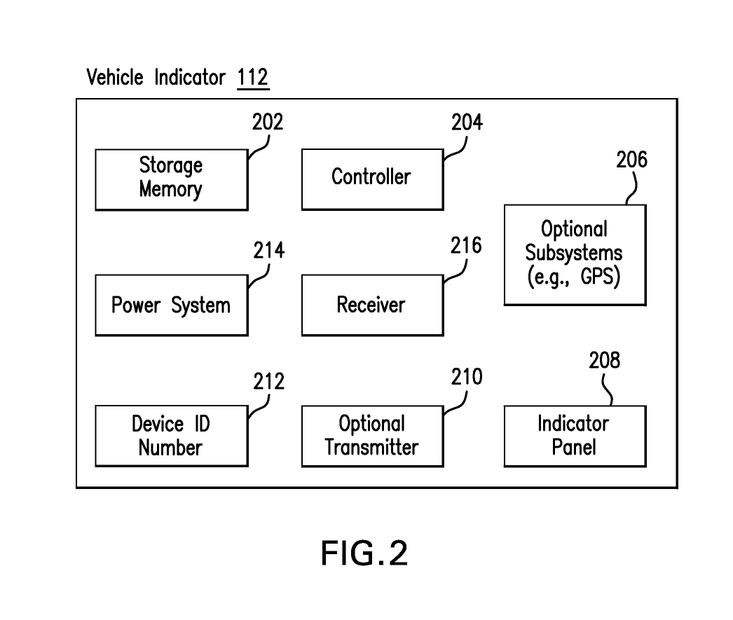

FIG. 2 illustrates a block diagram of an apparatus for verifying the status of a vehicle in accordance with the principles of the present invention. The vehicle indicator device 112 may preferably be a small device that may be physically associated or coupled with, or attached, connected, etc., to a vehicle. The indicator device may be attached or connected anywhere on, within, etc., the vehicle but may preferably be located near the rear of the vehicle in the case of visible or lighted indications. As an example, the indicator device 112 may be attached near the license plate or attached to, and/or forming part of, or becoming integral with, the license plate. As another example, the indicator device may be attached, connected, located, etc., on or near the tail light or bumper of the vehicle. In some embodiments, a second indicator may be used that may be attached near the front of the vehicle (e.g., on or near the front license plate). Especially for lighted or visible indications, such a front indicator may be used with a rear indicator to improve visibility from different perspectives. However, the indicator device may be attached, connected, located, etc., anywhere on, within, etc., the vehicle (even within the interior of the vehicle if non-visible signals are used to indicate status). The indicator device of the present invention may be made as an “after-market” device for installation on, within, etc., a vehicle, or the indicator device may be installed on, within, etc., a vehicle during the manufacturing of the vehicle itself, such as to become an integral or embedded part of a new vehicle.

According to some embodiments, the indicator device may comprise an enclosure containing the various components or electronics of the device. According to an embodiment of the present invention, the indicator device may be designed such that indicator lights will protrude and/or be emitted out of two of the four holes in the license plate (e.g., the two upper screw holes or the two lower screw holes) depending on how the license plate is attached. Indicator light(s) may be designed to remain lit as long as power is supplied and the vehicle is operational. However, the indicator light(s) may change color and/or turn off if the device is tampered with or disabled, or if there is a change in the status of information regarding the vehicle or any person associated with the vehicle that is represented by the indicator light(s). As another example of the present invention, an indicator device may have a mounting hole sized to accommodate the screws that attach a vehicle license plate such that it may be attached to the vehicle along with the license plate. In other embodiments, an indicator device 112 may be a thin device that attaches using adhesive to the surface of the vehicle's body or bumper or to the license plate.

The indicator device of the present invention may be connected to any power source or outlet in the vehicle. According to some embodiments, the indicator device 112 may attach to a brake light cover inside or outside the vehicle and, beneficially, may derive its power from the wiring to the brake or rear light(s). In other embodiments, where the indicator device 112 may be attached near the license plate, the indicator device 112 may derive its power from the light that illuminates the license plate. The indicator device may also derive its power from a battery and/or from its connection to the OBD output.

The indicator device may be a device or apparatus comprising a combination or set of integrally or functionally linked components that are each located on, in, within, or attached to, or coupled with, a particular vehicle. Although each of the various components of the indicator device may be present at different locations within, etc., the particular vehicle, they may be functionally linked by physical connection, such as by wiring, or by wireless communication. The indicator device 112 shown in FIG. 2 includes a controller 204, a receiver 216, a device ID number 212, and an indicator panel 208. Working in conjunction with one another, the receiver 216 may receive a signal from the satellite 114 or other transmitter and then the controller 204 (e.g., a microcontroller or microprocessor) can determine if the signal is addressed to, or is meant for, the vehicle indicator device 112 (e.g., based on its device ID number 212). If so, then the controller 204 may determine how to change the indicator panel 208 and/or cause the indicator panel 208 to be changed so that its indication signals conform to the instructions (i.e., the control signal(s)) received. One of ordinary skill will recognize that the protocols and signal parameters may be selected from a variety of alternatives without departing from the scope of the present invention.

The indicator panel 208 in FIG. 2 may be one or more visible lights (e.g., LED lights) that may include one or more different colors of light to indicate status information regarding the vehicle and/or any of its owners or operators. Instead of being an indicator “panel” per se, the indicator device may be described more simply as an indicator including one or more lighted indications or lights that are activated by a controller of the indicator device. However, the indicator of an indicator device of the present invention may instead generate or transmit a detectable but non-visible indication(s) or signal(s) that may then be detected or received by law enforcement, which may be in addition to a lighted display. A receiving device or receiver may be used by a law enforcement or police officer and may automatically detect and/or display information about a vehicle and/or one of its owners, occupants or registered drivers, such as on a visual screen, when the vehicle is near the receiving device. This may help to alert law enforcement about the presence of the vehicle when the transmitted indication or signal is within its reception area. Law enforcement may use this identifying information to run further background checks, etc., even during a routine traffic stop (e.g., a stop not based on an indication or signal from the indicator device).

According to embodiments of the present invention, the control signal sent from the control system may include some type of authentication and verification information embedded in the control signal(s) received by the indicator device 112 to ensure authentic signals are not easily spoofed. The device ID number 212 may be sufficient to uniquely identify each vehicle on the road. The device ID number 212 may be hard-coded into the indicator 112 when it is manufactured, or it may be a value that is encoded in the indicator 112 at some later time when the indicator 112 is put into use. The device ID number 212 may be stored in a memory of the vehicle indicator device 112 (see below). A power system 214, as mentioned above, may be tied into the electrical system of the car or connected to a battery, such as, for example, a rechargeable battery that may be rechargeable through solar energy or the motion of the vehicle. Replaceable batteries are contemplated as well. Additionally, the power system 214 may be configured to power the indicator 112 even when the vehicle is turned off.

According to some embodiments, the vehicle indicator device 112 may further include a vehicle-based transmitter 210. For example, the vehicle-based transmitter 210 of the indicator device 112 may acknowledge proper receipt of a signal and acknowledge performance of the instructions back to the control system 104. Because of the additional power usage and difficulty in broadcasting a signal sufficient to reach a satellite, the vehicle-based transmitter 210 may use other types of signaling protocols, such as radio, cellular, wireless, etc., to communicate information and/or acknowledgment back to the control system 104.

The indicator 112 can also include a memory 202 that stores information about the indicator 112 and the vehicle to which it is attached. For example, the license plate number, the expiration date, the insurance carrier, the policy number, the owner's name and contact information, and the vehicle identification number (VIN) of the vehicle are all examples of information that may be stored on the indicator 112. As mentioned above, the vehicle ID number may also be stored in the memory 202 of the indicator device 112. This information may be encoded into the memory 202 when the indicator is first registered with a user or by attachment and communication with the vehicle's computer system. For commercial vehicles, other relevant information, such as weight limits, highway tax information, and other safety related information, may be stored as well. According to some embodiments, the vehicle-based transmitter 210 may be configured to respond to an electronic interrogation device, such that the information in the memory 202 may be read from indicator 202. For this purpose, the storage memory 202 may be solid-state memory circuits or may be a magnetic stripe. However, any suitable form of storage may be used as the memory 202, although physically simpler and lighter forms of memory may be generally preferred. In this way, a law enforcement officer having the appropriate interrogator may determine pertinent information about the vehicle and/or its owners, registered users or occupants. A device used by law enforcement according to some embodiments may be both a receiving device and an interrogation device. Such a device may receive an indication of the presence of a vehicle and then query or interrogate the vehicle indicator device for additional information.

Embodiments of the present invention may also include other subsystems 206 as well. These subsystems 206 may not be essential to practicing every embodiment of the present invention but may in some instances provide additional benefits. The indicator device may be able to acquire additional information from these subsystems that may be stored in the memory of the indicator device and/or sent back to the control system. For example, an accelerometer assembly, subsystem or device may be configured to detect sudden changes in movement or acceleration/deceleration, such as to indicate or record that the vehicle was likely involved in a collision. This indication or recording may be time-stamped and/or in real-time, for example, to notify local authorities of an accident to assist first responders. Alternatively, information obtained via the accelerometer could just be a parameter that is stored on the indicator 112 and/or communicated back to the control system 104, which may be checked by law enforcement or other officials or by a future car buyer to ensure the integrity of the vehicle. Such an accelerometer device or subsystem may be a part of the indicator device or a part of, or within, the vehicle and/or in direct or indirect communication with the indicator device. Another optional subsystem may be a GPS tracking system or device to allow the location of the vehicle to be determined at almost any time. Such a GPS device or subsystem may be a part of the indicator device or a part of, or within, the vehicle and/or in direct or indirect communication with the indicator device. The GPS positioning information may be stored in the memory of the indicator device and/or communicated back to the control system. In other words, the indicator 112 can be queried for its position, which may be determined through an on-board GPS receiver, and this position may then be relayed back to the control system 104 using the vehicle-based transmitter 210. These subsystems may be part of the indicator device, or they may be part of the vehicle but in communication with the indicator device.

The indicator panel 208 of the indicator device 112 of FIG. 2 may include any of a variety of indicators that are capable of providing the appropriate signals to law enforcement personnel. For example, an LED may be used that when lit is either green or red (of course, two LEDs may be used to accomplish this as well). When the green LED is visible, this indicates that a valid insurance policy is in place on the vehicle associated with this indicator 112. If the red LED is lit, then this indicates that no insurance policy is in place. Alternatively, one LED could be used that when “ON” indicates good insurance and when “OFF” indicates a problem. Thus, if a law enforcement officer observes no LED lit or a red LED lit, then the vehicle may be pulled over under reasonable suspicion of a problem. However, any combination of colors and/or ON and OFF states are possible for conveying status information. Because the indicator 112 can also provide an indication of other items such as, for example, a valid vehicle registration, the indicator panel 208 may have a number of indicator lights as well to indicate different types of information. Regardless of the ultimate number of indicators present, these indicators are preferably visible or detectable under most outdoor conditions. To ensure detectability in low visibility conditions, cellular, wireless, or radio frequency indicators may also be used in addition to, or in place of, visible lights or LEDs to accommodate very bright conditions or adverse conditions, such as rain, snow and fog.

The indicators of the indicator device may also be used to display or send an indication or signal of distress if an occupant of the vehicle actuates a panic or emergency input or button. In addition to alerting people or law enforcement locally, the indicator device may also transmit or send a distress signal to the control system along with location information (e.g., location information from a vehicle or subsystem GPS). The control system may then contact or alert the nearest law enforcement officials in the area to attend to the vehicle and provide its location. The control system may access a database of law enforcement agencies and their contact information to determine which law enforcement agency location(s) is/are the closest to the vehicle. Such database may be the same database used by the control system to store other information. In addition or alternatively, the control system may send a transmitted signal, such as via the same transmitter or broadcaster used to send control signals to the indicator device, that may be received by local law enforcement officers (perhaps in a police car) to alert those officers of the distress signal and the location of the distressed vehicle. The law enforcement receiving device may determine if the transmitted signal is regarding a distressed vehicle that is nearby so that the law enforcement personnel or police car having the receiving device is alerted only if the distressed vehicle is determined to be close by or within a distance range. As with the indication signals described above, such a distress signal may instead be sent by the indicator device (e.g., as a satellite, cellular, radio, or other wireless or electromagnetic signal) and detected locally while bypassing the control system. In such a case, the law enforcement receiving device may determine if the distressed vehicle is local based on the location information in the distress signal.

According to one simple arrangement for a lighted indication of the present invention, a lighted indicator may be one color or turned on/off to indicate that there is a good or normal status for the vehicle (i.e., no issues reported or determined for the vehicle), whereas a different color of light or an opposing off/on state for the light may be used to indicate a problem or issue with regard to the vehicle. According to this arrangement, a police officer may have sufficient cause to pull the vehicle over (regardless of the reason or issue) to intercept the vehicle and its occupants based simply on a single indication, and then determine the cause for the alarm, signal or indication and take any further steps (such as make arrests, write citations, etc.) as needed. Such a simple arrangement could also be performed with a non-visible but detectable signal.

As for construction, the indicator 112 may be ruggedly built of a material that can withstand the harsh environment that most vehicles encounter. Many plastics and composite materials are available to choose from that provide indicator 112 with the necessary durability. The indicator 112 may also be constructed to reduce the possibility of tampering, such that the indicator device becomes disabled and/or displays or presents a tampering indication. For example, the indicator may be constructed of two halves welded along their seam so that they are inseparable. A tamper indicator or disabling mechanism or device may be included so that if an indicator 112 is somehow opened or tampered with, a normal or good status indication (e.g., a green LED light indicating insurance coverage) may be permanently disabled. Alternatively, instead of an absent signal, a tampering indication or signal may be presented.

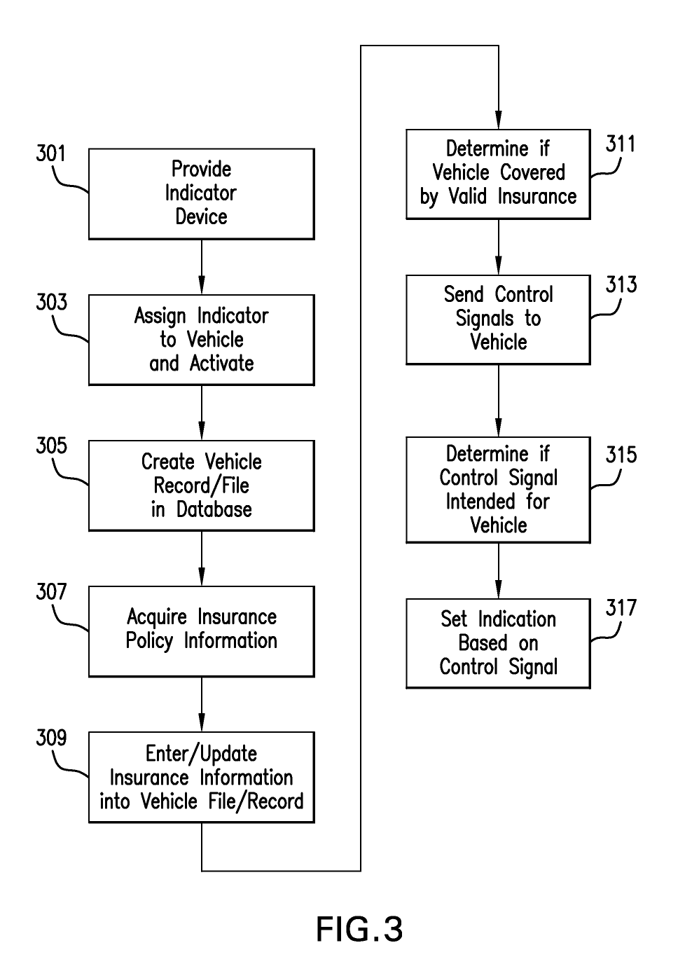

FIG. 3 is a flowchart of a method of verifying insurance in accordance with principles of the present invention. In step 301, an owner or other individual acquires a vehicle indicator device for a particular vehicle, perhaps at the time of purchasing the vehicle, at the time of purchasing or taking out an insurance policy for the vehicle, due to changes in the law or voluntarily. The indicator device may be supplied by an insurance company, state or local authorities, or from a retail outlet. The indicator device may then be activated and/or registered and associated with the particular vehicle in step 303, such as with the VIN number for the vehicle. This may be done by associating a device ID number with the vehicle VIN number, and these values or identities may be entered into a new record or file of the present system (e.g., in the control system database) for monitoring as in step 305. Registration or activation of the indicator device may be done by a control signal or instruction sent from the control system with the registration/activation being generated by entering information and authorizations into a user interface of the control system. Of course, the indicator device must then be physically attached or connected to the vehicle (e.g., attached to the rear license plate) if not already done. One of ordinary skill will recognize that the indicator device may be purchased by a customer and then brought to the insurance company for activation, or the indicator device may be purchased from the insurance company, or provided for free as a part of their service, or provided by the government or other entity to facilitate implementation of the infrastructure of this system.

Once the indicator device is associated with a vehicle, the control system may then acquire, receive, etc., up-to-date information or records regarding any insurance coverage for the vehicle (as well as other vehicles in the database) in step 307 from the insurance company/companies via a network, which may be acquired, received, etc., in total (or in part if only some portions of the record are sent/received or updated). This insurance policy information or records may then be stored in the control system database in step 309 to fill in or update the insurance policy information of the file/record associated with the indicator device and vehicle. The control system may then determine in step 311 if the vehicle is covered by a valid and up-to-date insurance policy in step 311. The control system may also determine if the vehicle is covered by more than one active insurance policy. Because having multiple insurance policies on a vehicle can sometimes be used to commit insurance fraud, detecting the existence of an already valid policy may be beneficial. Based on the determination in step 311 of the status of insurance policy coverage for a particular vehicle, the control system may create and send a control signal in step 313 to the indicator device of the vehicle via a transmitter that may be linked to the control system by a network. According to some embodiments, a control signal may only be sent if there is a change of status or if it is determined that there is not a valid and current insurance policy in place. According to other embodiments, a control signal will be sent regardless of status (valid or invalid) intermittently or periodically or if there is any status change. As mentioned above, the indicator device may also determine or check if the control signal is intended for the indicator device in step 315 by comparing and determining if there is a match between identifying information encoded or stored in the indictor device (e.g., device ID number or VIN) and identifying information embedded in the control signal, which may be done by a controller or processer present in the indicator device. In response to receiving the control signal, the indicator device may then set and present, display, send, transmit, etc., a corresponding indication or signal, such as a lighted indication or wireless signal, in step 317 to indicate the status of the insurance policy coverage for the vehicle.

According to example embodiments of the present invention, if an insurance customer maintains insurance for a vehicle, then the control system's database may be periodically updated as the policy is renewed so that the indicator device always indicates a valid insurance policy. If, however, the customer allows the insurance policy to lapse (or cancels the policy altogether), then the control system and database may receive an insurance policy information or update from the insurance company. This insurance policy information may be sent individually by the insurance company, or it may be sent as a batch message with a number of policies, or it may be proactively retrieved from the insurance company's computers by the control system.

The control system may then determine if a valid insurance policy is in place for a vehicle and possibly send a control signal to the indicator device based on that determination. The control system may also check in its database to ensure that no replacement policy has been bought for the same vehicle (e.g., based on the VIN or device ID number) after a policy is cancelled or not renewed. If no valid policy is in place for that vehicle or VIN, then the indicator device associated with that vehicle may be sent a control signal to instruct that no insurance policy is in place. As a result, in step 408, the indicator device changes its display to indicate that the vehicle is not covered by a valid insurance policy. According to some embodiments, the control system may determine from the expiration date of a policy in the database when a policy lapses if no update has been received. Thus, no direct communication with an insurance company may be needed if the insurance policy information is received passively by download from the insurance company database.

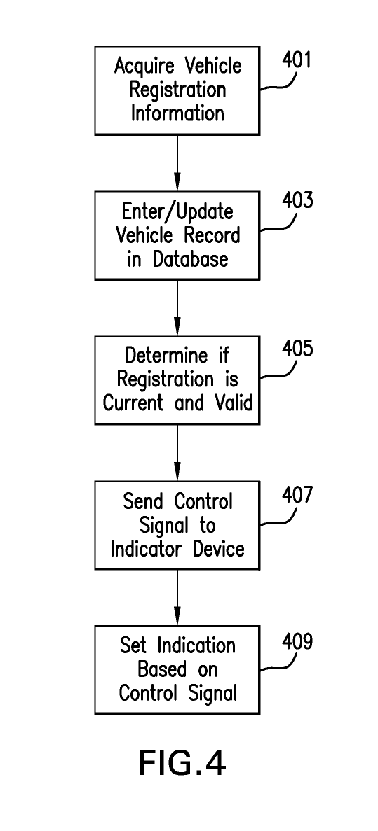

According to an analogous set of steps presented in FIG. 4, the control system of the present invention according to some embodiments may acquire vehicle license and registration information from a state or local government database in step 401. In step 403, this information may be entered or used to update the file or record corresponding to the vehicle in the control system database. The control system may then determine or verify if a valid registration is in place for a vehicle in step 405. As an alternative, this license and registration information may only be accessed and utilized when the control system seeks to make the determination in step 405 (i.e., without step 403). If a valid registration is not in place for the vehicle, then a control signal may be generated and sent by the control system to the vehicle indicator device in step 407 via a network and/or transmitter. The vehicle indicator device may then change the status setting and indication or signal presented, sent, transmitted, etc., by the indicator device in step 409 to represent the license and registration status of the vehicle (e.g., valid and current or invalid).

As mentioned above, the indicator device may present, send, transmit, etc., indications or signals to depict all sorts of status information based on data or information received by the control system and/or the indicator device. As explained above, such information may be local to the vehicle and detected by the indicator device (and sent to the control system), or such information may be received from remote sources or third party databases, such as insurance company, government and/or law enforcement databases, which may be accessed or connected via a network. Thus, the system and methods of the present invention further provide secondary benefits because of its centralized storage of relevant information and its methods of reaching vehicles having an indicator device. For example, when law enforcement personnel have information about a vehicle's description, a license plate number, a suspect's name or some combination of those, the control system may be utilized to send a control signal to the indicator device instructing the indicator device to present an indication or send a detectable signal. A wanted person's report, a missing person's report, an amber alert, a stolen vehicle report, or an all-points bulletin may all help law enforcement identity an involved vehicle.

The indicator device or vehicle identity information may be used by the control system and its database to send a control signal to the indicator device on the appropriate vehicle. When a law enforcement officer sees a vehicle having the “wrong” indication or signal from or on the indicator device, it provides reason to stop that vehicle. Although it may add complexity to the indicator device, a separate, additional indicator signal that would indicate an “emergency” condition is also contemplated. As described above, a simple on/off or color change for a lighted indication may be used to indicate that there is a problem or issue with a particular vehicle that is worth investigating. Alternatively, a variety of different indications or signals may be used to convey different kinds of status information regarding the vehicle.

According to another set of embodiments, contact information and policy information stored in the database may be utilized by the control system to send periodic messages to vehicle owners regarding policy or registration renewal periods and deadlines and other information. Text messages, e-mail messages, telephone calls, regular mail, etc., may all be used if appropriate contact information is available.

The previous description is provided to enable any person skilled in the art to practice the various embodiments described herein. Various modifications to these embodiments will be apparent to those skilled in the art based on the present description. Thus, the claims are not intended to be limited to the embodiments and examples shown herein, but are to be accorded their full scope consistent with each claim's language. All structural and functional equivalents to the elements of the various embodiments described throughout this disclosure that are known or later come to be known to those of ordinary skill in the art are expressly incorporated herein by reference and are intended to be encompassed by the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A system for determining a status of a vehicle, comprising:
a control system database for storing one or more records, each record having status information for a particular vehicle and an associated vehicle identification number for the particular vehicle;
a control system server configured to acquire the one or more records from an external database associated with an external server and store the one or more records in the control system database, the control system being further configured to determine a status for the particular vehicle associated with the vehicle identification number based on the status information in a respective record stored in the control system database;
a broadcast transmitter configured to transmit a control signal, wherein the broadcast transmitter is further configured to receive the control signal communicated from the control system via the network, and wherein the control signal includes one or more instructions based on the status for the particular vehicle as determined by the control system; and
an indicator device having a receiver configured to receive the transmitted control signal from the broadcast transmitter,
wherein the control system is in communication with the external server associated with the external database such that the status information of each of the one or more records is communicated from the external server to the control system via the network, and
wherein the indicator device is attached to the particular vehicle, the indicator device being further configured to display or send a detectable indication based on the instructions of the control signal received by the indicator device.

2. The system of claim 1, wherein the broadcast transmitter is one or more of a satellite, a radio transmitter, a cellular network, a pager system, and a wireless network.

3. The system of claim 1, wherein a controller of the indicator device is further configured to determine if the transmitted control signal is addressed to the indicator device based on a device identification number associated with the indicator device or a vehicle identification number associated with the particular vehicle, and
wherein the controller of the indicator device is further configured to direct the displaying or sending of the detectable indication as instructed by the control signal if the transmitted signal is determined to be addressed to the indicator device for the particular vehicle.

4. The system of claim 1, wherein the detectable indication of the indication device is a lighted indication.

5. The system of claim 1, wherein the detectable indication of the indication device is non-visible and one or more of a satellite, cellular, wireless, or radio frequency signal.

6. The system of claim 1, wherein the status information of each of the one or more records is an insurance policy status for the particular vehicle acquired from an external insurance company server or database, and wherein the indicator device displays or sends the detectable indication according to the control signal if a valid insurance policy is not in place for the particular vehicle.

7. The system of claim 1, wherein the status information in each of the one or more records is a registration status for the particular vehicle acquired from an external governmental server or database, and wherein the indicator device displays or sends the detectable indication according to the control signal if a valid registration is not in place for the particular vehicle.

8. The system of claim 1, wherein the status information in each of the one or more records is whether the particular vehicle or an owner or registrant of the particular vehicle has been involved in a crime or traffic violation, wherein each of the one or more records is acquired from a law enforcement server or database, and
wherein the indicator device displays or sends the detectable indication according to the control signal if the particular vehicle or the owner or registrant of the particular vehicle has been involved in a crime or traffic violation.

9. The system of claim 1, wherein the indicator device further includes a transmitter configured to send a report signal, the report signal being non-visible and one or more of a satellite, cellular, wireless, or radio frequency signal, wherein the report signal includes information about the vehicle or events occurring within or near the vehicle.

10. The system of claim 9, wherein the transmitter of the indicator device is further configured to send the report signal to the control system server via the network.

11. The system of claim 10, wherein the information contained in the report signal includes information about one or more of: identity and contact information for an owner or registrant of the particular vehicle; vehicle identification number (VIN) for the particular vehicle; one or more driving restrictions for an owner or registrant of the particular vehicle; driving and operational history or information from a computer or on-board diagnostic (OBD) system of the vehicle; location and speed information from a global positioning system (GPS) device within the vehicle; acceleration, deceleration or collision information from an accelerometer within the vehicle; presence of a house arrest device within the vehicle; or information about cell phone usage within the vehicle.

12. The system of claim 10, wherein the control system server is further configured to send a control signal to the indicator device to trigger the indicator device to transmit the report signal to the control system.

13. The system of claim 9, wherein the report signal is detectable near the vehicle by a law enforcement receiving device.

14. An indicator device for coupling with a vehicle, comprising:
a receiver configured to receive a control signal from a remote control system server, the control signal sent by the control system server to the indicator device via a broadcast transmitter, the control signal having one or more instructions that are determined by the control system server based on status information for the vehicle;
a controller configured to determine if the control signal is addressed to the indicator device based on a unique device identification number associated with the indicator device or a vehicle identification number associated with a vehicle; and
an indicator configured to display or send a detectable indication,
wherein the controller controls the display or sending of the detectable indication of the indicator based on the one or more instructions of the control signal if the control signal is determined by the controller to be addressed to the indicator device.

15. The indicator device of claim 14, wherein the detectable indication is a lighted indication.

16. The indicator device of claim 14, wherein the detectable indication is a satellite, cellular, wireless, or radio frequency signal.

17. The indicator device of claim 16, wherein the detectable indication is receivable by a law enforcement receiving device near the particular vehicle.

18. The indicator device of claim 14, wherein the indicator device is shaped and configured to attach to a license plate of the vehicle.

19. The indicator device of claim 14, wherein the receiver is further configured to receive vehicle-based status information about the vehicle or an event or activity occurring within or near the vehicle.

20. The indicator device of claim 14, further comprising:
a second receiver, wherein the second receiver is configured to receive vehicle-based status information about the vehicle or an event or activity occurring within or near the vehicle.

21. The indicator device of claim 20, wherein the vehicle-based status information includes information about one or more of the following: driving and operational history or information from a computer or on-board diagnostic (OBD) system of the vehicle; location and speed information from a global positioning system (GPS) device within the vehicle; acceleration, deceleration or collision information from an accelerometer within the vehicle; presence of a house arrest device within the vehicle; or information about cell phone usage within the vehicle.

22. The indicator device of claim 21, wherein the vehicle-based status information includes information about cell phone usage within or near the vehicle.

23. The indicator device of claim 22, wherein the controller of the indicator device is further configured to control the operation of a blocking antenna to block cell phone usage within the vehicle, wherein the controller activates the blocking antenna when cell phone usage is detected by the second receiver while the vehicle is moving.

24. The indicator device of claim 21, wherein the controller of the indicator device is further configured to store the vehicle-based status information in a memory of the indicator device.

25. The indicator device of claim 20, further comprising:
a vehicle-based transmitter, wherein the vehicle-based transmitter is configured to send a report signal, the report signal including at least a portion of the vehicle-based status information received by the second receiver.

26. The indicator device of claim 25, wherein the vehicle-based transmitter is configured to send the report signal to the control system server via a network.

27. The indicator device of claim 25, wherein the vehicle-based transmitter is configured to send an acknowledgment signal to the control system server to acknowledge receipt of the control signal from the broadcast transmitter.

28. A vehicle comprising the indicator device of claim 14.

29. A method for determining a status of a vehicle, comprising:
(a) acquiring by a control system server one or more records from an external database associated with an external server, the one or more records acquired via a network, wherein each record includes status information for a particular vehicle and a device identification number for an indicator device or an associated vehicle identification number for the particular vehicle;
(b) determining a status of the particular vehicle by the control system server based on the status information in a respective record for the particular vehicle; and
(c) transmitting a control signal via a broadcast transmitter, wherein the control signal is communicated from the control system server to the broadcast transmitter via the network, wherein the control signal includes one or more instructions based on the status for the particular vehicle as determined by the control system server.

30. The method of claim 29, further comprising:
(d) storing the one or more records in a control system database associated with the control system server.

31. The method of claim 29, further comprising:
(e) receiving the transmitted control signal by a receiver of the indicator device attached to the particular vehicle; and
(f) determining by a controller of the indicator device whether the received control signal is addressed to the indicator device based on a device identification number for the indicator device or a vehicle identification number for the particular vehicle.

32. The method of claim 31, further comprising:
(g) displaying or sending a detectable indication by the indicator device based on the instructions of the control signal received by the indicator device.

33. The method of claim 32, wherein the detectable indication is a satellite, cellular, wireless, or radio frequency signal.

34. The method of claim 33, further comprising:
(h) receiving the detectable indication by a law enforcement receiving device located in the vicinity of the vehicle.

35. The method of claim 32, wherein the status information of each of the one or more records acquired by the control system server in step (a) is an insurance policy status for the particular vehicle acquired from an external insurance company server or database, and
wherein the indicator device displays or sends the detectable indication in step (g) according to the control signal if a valid insurance policy is not in place for the particular vehicle.

36. The method of claim 32, wherein the status information in each of the one or more records acquired by the control system server in step (a) is a registration status for the particular vehicle acquired from an external governmental server or database, and
wherein the indicator device displays or sends the detectable indication in step (g) according to the control signal if a valid registration is not in place for the particular vehicle.

37. The method of claim 32, wherein the status information in each of the one or more records acquired by the control system server in step (a) is whether the particular vehicle or an owner or registrant of the particular vehicle has been involved in a crime or traffic violation, wherein each of the one or more records is acquired from a law enforcement server or database, and
wherein the indicator device displays or sends the detectable indication in step (g) according to the control signal if the particular vehicle or the owner or registrant of the particular vehicle has been involved in a crime or traffic violation.

38. The method of claim 32, wherein the indicator device further includes a transmitter configured to send a report signal, the report signal being non-visible and one or more of a satellite, cellular, wireless, or radio frequency signal, wherein the report signal includes information about the vehicle or events occurring within or near the vehicle.

39. The method of claim 31, further comprising:
(i) receiving by the indicator device vehicle-based status information about the vehicle or an event or activity occurring within or near the vehicle,
wherein the status information is received by a second receiver of the indicator device.

40. The method of claim 29, further comprising:
(i) receiving by the indicator device vehicle-based status information about the vehicle or an event or activity occurring within or near the vehicle.

41. The method of claim 40, wherein the vehicle-based status information includes information about one or more of the following: driving and operational history or information from a computer or on-board diagnostic (OBD) system of the vehicle; location and speed information from a global positioning system (GPS) device within the vehicle; acceleration, deceleration or collision information from an accelerometer within the vehicle; presence of a house arrest device within the vehicle; or information about cell phone usage within the vehicle.

42. The method of claim 41, wherein the vehicle-based status information includes information about cell phone usage within or near the vehicle.

43. The method of claim 42, further comprising:
(j) controlling the operation of a blocking antenna located inside the vehicle, wherein the controlling step comprises activating the blocking antenna when cell phone usage is detected by the indicator device while the vehicle is moving.

44. The method of claim 40, further comprising:
(k) storing the received vehicle-based status information in a memory of the indicator device.

45. The method of claim 40, further comprising:
(l) sending a report signal by a vehicle-based transmitter of the indicator device, wherein the report signal includes at least a portion of the vehicle-based status information received by the indicator device.

46. The method of claim 45, wherein the vehicle-based transmitter sends the report signal to the control system server via the network in step (l).

47. The method of claim 46, further comprising:
(m) storing the vehicle-based status information contained in the report signal in a remote control system database associated with the control system server.

48. The method of claim 45, further comprising:
(n) receiving the report signal by a law enforcement receiving device located in the vicinity of the vehicle.

49. The method of claim 48, wherein the report signal further includes one or more of the following: an identity and contact information for an owner or registrant of the vehicle; a vehicle identification number (VIN) for the vehicle; one or more driving restrictions for an owner or registrant of the particular vehicle.

50. The method of claim 48, further comprising:
(o) displaying the vehicle-based status information of the report signal by the law enforcement receiving device.

51. A method comprising the following steps:
(a) receiving by an indicator device a control signal transmitted by a control system to the indicator device via a broadcast transmitter, wherein the indicator device is attached to a particular vehicle, and wherein the control signal includes one or more instructions based on a status for the particular vehicle as determined by the control system;
(b) determining by a controller of the indicator device whether the received control signal is addressed to the indicator device based on a device identification number for the indicator device or a vehicle identification number for the particular vehicle;
(c) displaying or sending a detectable indication by the indicator device based on the instructions of the control signal received by the indicator device if the control signal is determined in step (b) to be addressed to the indicator device.

52. The method of claim 51, further comprising:
(d) receiving the detectable indication by a law enforcement receiving device located in the vicinity of the vehicle.

53. The method of claim 51, further comprising:
(e) receiving by the indicator device vehicle-based status information about the vehicle or an event or activity occurring within or near the vehicle.

54. The method of claim 53, further comprising:
(f) storing the received vehicle-based status information in a memory of the indicator device.

55. The method of claim 53, further comprising:
(g) sending a report signal by a vehicle-based transmitter of the indicator device, wherein the report signal includes at least a portion of the vehicle-based status information received by the indicator device.

56. The method of claim 55, wherein the vehicle-based transmitter sends the report signal to the control system server via the network in step (g).

57. The method of claim 56, further comprising:
(h) storing the vehicle-based status information contained in the report signal in a remote control system database associated with the control system server.

58. The method of claim 57, further comprising:
(i) receiving the report signal by a law enforcement receiving device located in the vicinity of the vehicle.
